(19) United States
(12) Patent Application Publication
(10) Pub. No.: US 2025/0140943 A1
(43) Pub. Date: May 1, 2025

(54) A CIRCUIT MODULE FOR CONTROLLING A PLURALITY OF ENERGY CELL UNITS

(71) Applicant: HAGAL TECHNOLOGY AS, Oslo (NO)

(72) Inventors: William BRAATHEN, Vollen (NO); Jonathan Edvard BJERKEDOK, Krokstadelva (NO)

(21) Appl. No.: 18/707,344

(22) PCT Filed: Oct. 26, 2022
(86) PCT No.: PCT/NO2022/050244

§ 371 Date: May 3, 2024

(30) Foreign Application Priority Data
Nov. 5, 2021 (NO) 20211336

(51) Int. Cl. H01M 10/42; H01M 50/51; H02J 7/00

(52) U.S. Cl. CPC H01M 10/425; H01M 50/51; H02J 7/0013; H02J 7/00711; H01M 2010/4271; H02J 2207/50

(57) ABSTRACT

A circuit module for coupling a plurality of energy cell units is disclosed. Energy modules, energy clusters, energy systems and cascaded circuitry comprising such circuit modules are also disclosed.

### FIELD OF THE INVENTION

The present invention generally relates to energy storage systems such as battery systems. More specifically it relates to a circuit module for controlling a plurality of energy cell units. Further it relates to energy modules, energy clusters and energy systems comprising such circuit modules.

### BACKGROUND OF THE INVENTION

Energy storage systems for applications such as full electric vehicles, hybrid electric vehicles, and stationary energy storage in grid connected or off grid applications, frequently include an arrangement of multiple energy storage cell units.

In energy storage systems that include multiple energy storage units, differences between cell units can impact how the overall energy storage system performs. In particular, in battery systems including re-used battery cell units, such differences between the cell units can be prominent. Moreover, a single bad cell unit may undesirably affect the performance and reliability of the overall system.

Conventional battery management systems typically use switched resistors to dissipate surplus energy from higher charged cell units, or switched capacitors or switched inductors to transfer energy from higher charged cell units to lower charged cell units. The primary role of these systems is to equalise the state of charge differences of cell units connected in series at a particular point in the charge discharge cycles, for example at the end of charging. Equalising the state of charge at one specific point in the cycle ensures that the lowest capacity cell unit in a series arrangement is able to be fully charged and discharged throughout the cycle. It does not, however, allow higher capacity cell units to be fully charged and discharged throughout the cycle.

In order to overcome the limitations posed by the lowest capacity cell unit in an energy storage system comprising multiple cell units connected in series, a more advanced approach is required.

It is an aim of the invention to provide a battery system which overcomes or ameliorates one or more of the disadvantages or problems described above, or which at least provides the consumer with a useful choice.

For an energy storage device, each cell unit is limited by its functional mechanism and design to provide an output voltage within a certain range depending on its state of charge and operating conditions. Each cell unit is also limited by its functional mechanism and design to provide a certain maximum charge storage capability, depending on the operating conditions. Electrically connecting cell units in series increases the maximum achievable output voltage, therefore decreasing the magnitude of current required to supply a given power output. This increases the system efficiency as ohmic losses increase with current magnitude. Electrically connecting cell units in parallel increases the maximum achievable storage capacity for a given cell unit capacity and storage system output voltage level.

The individual cell units inevitably display some differences in terms of charge storage capacity, internal resistance, and other performance related factors. Even before entering their operating life, cell units inevitably have differences caused by manufacturing tolerances that allow for certain variations in cell units during manufacturing with even state of the art manufacturing processes. Throughout the operating life, variations in cell unit performance degradation conditions or profiles further contribute to these differences. In applications in which used cell units are recycled for re-use, the cell units can be associated with notable performance differences, particularly if the cell units have been exposed to different usage profiles. Utilising cell units with different specifications can also contribute to cell unit differences.

In energy storage systems that include multiple energy storage units, such differences between cell units can impact how the overall energy storage system is managed and performs. In cell units that are electrically connected in parallel, lower performing cell units contribute or accept a lower current during a discharge or charge process, respectively. This leads to higher performing cell units contributing to or accept a higher current during a discharge or charge process, respectively. Such rate increases can decrease the system efficiency, increase cell unit degradation, and potentially present safety risks. It is therefore often necessary to constrain the entire system to a lower power input or output level. In cell units that are only electrically connected in series, lower charge capacity cell units can contribute or accept less electric charge during a discharge or charge process, respectively. Due to the series arrangement, higher charge capacity cell units are limited to contribute only an equal amount of charge as the lowest charge capacity cell unit. This means that the cell unit with the lowest charge capacity limits the charge storage capacity of the full energy storage system.

Switches can also be used to connect or bypass the cell units. By bypassing lower-performing cell units, additional charge and discharge capacity can be unlocked from the other cell units. Some disadvantages of current systems using this approach are that for each cell unit connected in series, an additional switch is placed in any given current path contributing an associated on resistance and energy loss.

With an increasing demand for efficient high voltage and high energy from modulated energy storage sources, chargers and inverters for grid support, motor control, solar panel and similar applications combined with latest battery technology and low on resistance in switches, direct synthetization of high voltage and high current based on individual cell level switching has become possible. As an example a 230V AC generation from single cell serial switching topology can easily end up with 150-160 transistors in a serial chain which creates a need for a new approach with cluster of modules topology of energy cells which will cause the amount of active electronic switches, transistors or similar in a chain for any cluster of modules to be reduced or become more optimized for each application.

Introducing a module concept that can bypass all cells in an entire module or have a fixed link in-link out budget of active transistors, resulting in a fixed (limited) number of chained transistors (switching devices) in a serially coupled chain of cells makes these types of applications more efficient.

The second highlight and the reinforcing element of this invention is that a redundant bypass function in those modules that are not active in a cluster will both increase the probability that weak modules is not becoming a destructive element in a cluster and that an active use of multiple paths in a redundant switch network within each module further reduces the connected resistance for the short circuit function of the module. This enables more overprovision in a cluster without adding significant serial resistance in the total cluster budget for a passive spare pool of modules.

### SUMMARY OF THE INVENTION

A first aspect of the invention is a circuit module for controlling a plurality of energy cell units, where the circuit module having two terminals for external connection connected to the switching assembly, the circuit module including
a set of two terminals for each energy cell where the second terminal of the first cell is connected to the first terminal of the second cell, and where the second terminal of the second cell is connected to the first terminal of the third cell, for the connection to form a permanently connected serial chain of energy cells containing 3 or more energy cells,
the first terminal from the first (1) and every odd energy cell (1, 3, 5, 7 . . . ) following in the serial chain and the second terminal of the last cell in a chain with an even energy cell count (4, 6, 8, 10 . . . ) connected to a switching assembly,
the second terminal from the first (1) and of every odd energy cell (1, 3, 5, 7 . . . )
following in the serial chain connected to a switching assembly,
wherein the switching assemblies are operatively configured to selectively connect or disconnect each one of the energy cell units, each switching assembly including one or more switching devices, each switching device operable in a conductive state and a non-conductive state,
wherein the switching assemblies are operatively configured to selectively allow operating in a plurality of states,
   a first state wherein the two terminals with a selectively arrangement of none conductive switches forms circuit module is an open circuit,
   a second state wherein the two terminals of the circuit module is a short circuit, and wherein all energy cell units are selectively disconnected having the adjacent switches in a nonconductive state, having the short circuit path selectively arranged through a redundant network with more than one possible route of conductive switches and where alternative short connection routes are none are a overlapping use of conductive switches for all alternatives,
   a third state wherein the two terminals of the module is a short circuit, wherein all energy cell units are disconnected having the switches selectively arranged in a way where a multiple of redundant switches are set to conductive state simultaneously resulting in a reduced switching equivalent active resistance,
   a plurality of states depending on the length of the serial chain of energy cells wherein the two terminals of the module is selectively connected to one or an odd count of energy cells in which any single energy cell alone or with an odd count of selective number of successive energy cells in the serial chain in the module circuitry, each state including a charging cycle and a discharging cycle of the energy cell units connected in series.

Optionally, selective assembly of switches effectively will switch the polarity on the circuit module terminals.

Optionally, a switch device can be any type of electronic switch: BJT, MOSFET, IGBT, Thyristor, relay, and electromechanical switch.

Optionally, the circuit module is arranged for using PWM (pulse with modulation) by selectively alternating one or more switches at high speed together with filtration to generate higher voltage precision.

Optionally, the circuit module, as standalone or a plurality of clusters is used as motor controller, charger, inverter, transformer or other energy conversion devices.

A further aspect of the invention, is an energy module comprising a circuit module according to one of the claims above, and the serial chain of energy cells.

Optionally, an energy cell is a battery cell, capacitor, super-cap, or any other device that can store energy.

A further aspect of the invention is an energy cluster, comprising a plurality of energy modules as described above, for energy input and output as charge and discharge and possibly both at the same time.

Optionally, the energy cluster comprises a plurality of energy modules connected in in serial, in parallel or in a plurality of combinations of parallel and serial combined.

Optionally, the plurality of modules is arranged to modulate voltage and current to be DC, AC or other voltage and current with unspecified frequency spectrum.

Optionally, the energy cluster comprises a plurality of clusters configured to work together as 3-phase, 4-phases, 5 or more phases.

A further aspect of the invention is a cascaded circuitry arranged according to the same principles as the circuit module, comprising a structure of modules in a superstructure where each energy cell in a first level is replaced individually by at module in a plurality chain of modules, and for the subsequent plural levels of a superstructures where each energy cell equivalents are replaced by a lower level module topology as in circuit module.

### DESCRIPTION OF THE FIGURES

The above and further features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following figures, wherein:

FIG. 1A, 2A, 3A, 4A are principle circuit diagrams of a circuitry module according to one embodiment of the invention

FIG. 1B, 2B, 3B, 4B are example of circuit diagrams of a circuitry module according to one embodiment of the invention.

FIG. 5A is a Module symbol for an Energy Module indicating a plurality of energy cells.

FIG. 5C is an example of a three individual clusters of Energy Modules connected in parallel and in series.

FIG. 5D is an example of three individual cluster of Energy Modules connected in series.

FIG. 6A is a cascaded circuitry similarity and assembled under the same principles as a circuit module claim 1, a structure of modules in a superstructure where each energy cell in the first level is replaced individually by at module in a plurality chain of modules, and for the subsequent plural levels of a superstructures where each energy cell equivalent module are replaced by a lower level module topology

FIG. 6B is an example of a circuit diagram for FIG. 6A

FIG. 7 corresponds to FIG. 1

### DESCRIPTION OF PREFERRED EMBODIMENTS OF THE INVENTION

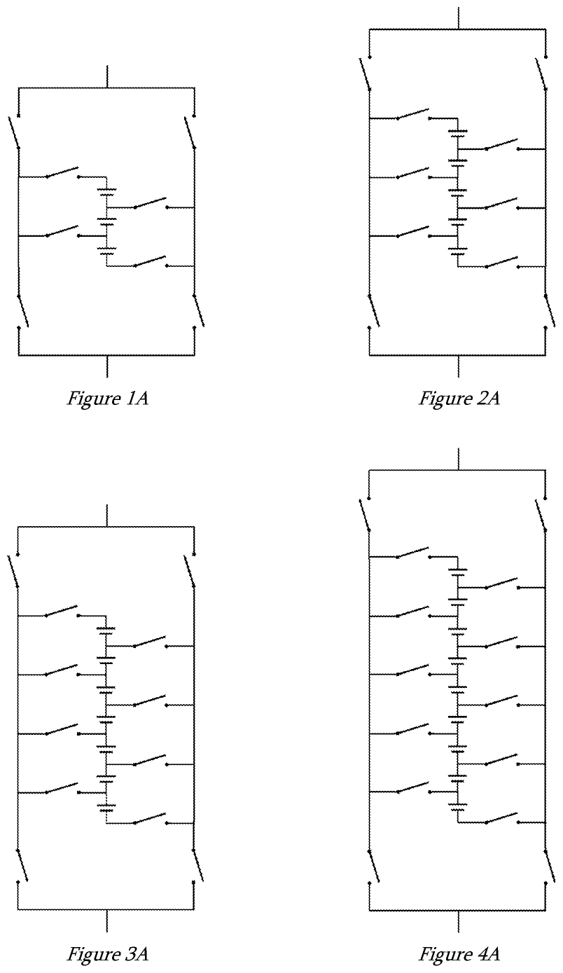

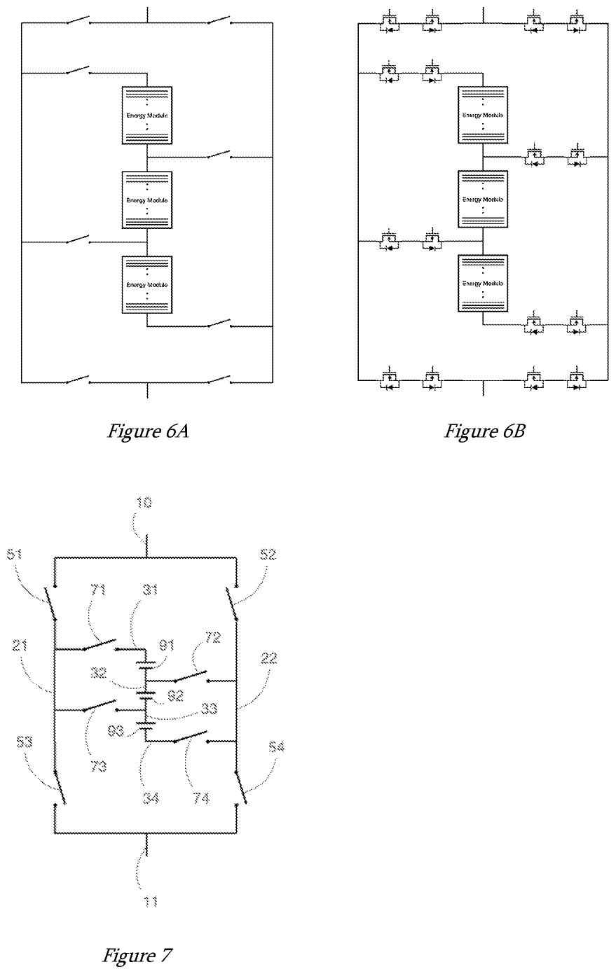

The main principles of the present invention are described below with reference to the embodiment show in FIG. 1A and the corresponding FIG. 7 where reference
numbers are specified.

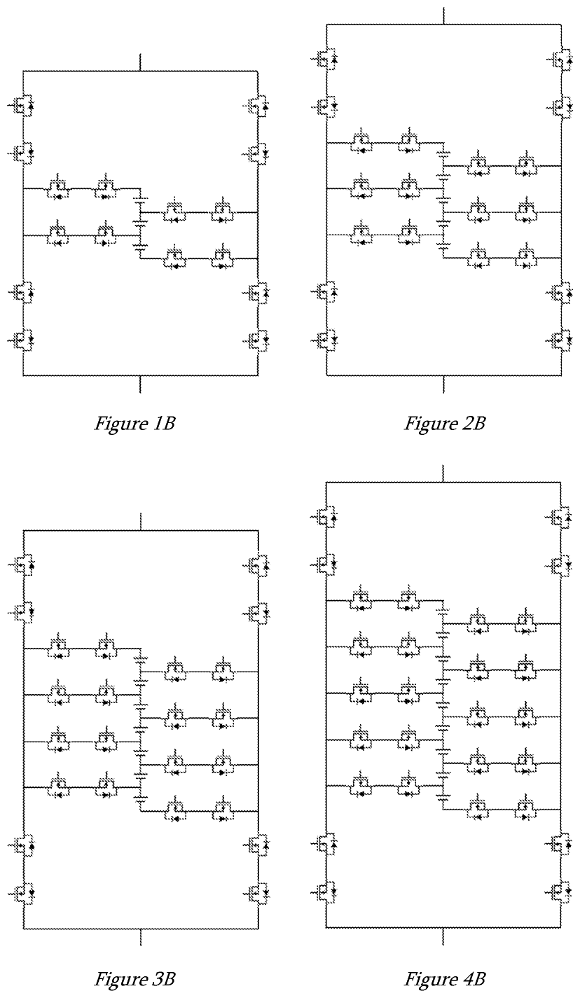

a set of two external terminals (10) and (11) allowing energy to flow in and out of the circuit module in a plurality of states,
a first state wherein the circuit module will be seen externally as shown in FIG. 5A as a black box become with open circuit if the switch assembly of switch (51), switch (53), switch (53) and switch (54) are all selectively configured to be none conductive, and possibly short circuit energy cell (91) and energy circuit (92) if switches (71, 73) being in conductive state,
and possibly short circuit energy cell (92) and energy circuit (93) if switches (72, 74) being in conductive state,
as the switches (71, 72, 73, 74) shall normally be selectively configured as nonconductive,
a second state wherein the circuit module will be seen externally as shown in FIG. 5A as a short circuit if the path connection (10) through conductive switches (51) via connection (21) to conductive switch (53) and to connection (11) and switch (52) and switch (54) and switches (71,72, 73,74) being in a none conductive stage,
or the circuit module will be seen externally as shown in FIG. 5A as a short circuit if the path connection (10) through conductive switches (52) via connection (22) to conductive switch (54) and to connection (11) and switch (51) and switch (53) and switches (71,72, 73,74) being in a none conductive stage,
a third state wherein the circuit module will be seen externally as shown in FIG. 5A as a short redundant short circuit path providing a reduced conductive resistance when connection (10) through conductive switches (51) via connection (21) to conductive switch (53) and to connection (11), and while also connection (10) through conductive switches (52) via connection (22) to conductive switch (54) and to connection (11),
a plurality of states,
the circuit module will be seen externally as shown in FIG. 5A as the single energy cell (91) with a none inverted polarity if switches (51, 54, 71, 72) are set to conductive state and switches (52, 53, 73, 74) are set to none conductive state,
the circuit module will be seen externally as shown in FIG. 5A as the single energy cell (91) with an inverted polarity if switches (52, 53, 71, 72) are set to conductive state and switches (51, 54, 73, 74) are set to none conductive state,
the circuit module will be seen externally as shown in FIG. 5A as the single energy cell (92) with a none inverted polarity if switches (52, 53, 72, 73) are set to conductive state and switches (51, 54, 71, 74) are set to none conductive state,
the circuit module will be seen externally as shown in FIG. 5A as the single energy cell (92) with an inverted polarity if switches (51, 54, 72, 73) are set to conductive state and switches (52, 53, 71, 74) are set to none conductive state,
the circuit module will be seen externally as shown in FIG. 5A as the single energy cell (93) with a none inverted polarity if switches (51, 54, 73, 74) are set to conductive state and switches (52, 53, 71, 72) are set to none conductive state,
the circuit module will be seen externally as shown in FIG. 5A as the single energy cell (93) with an inverted polarity if switches (51, 52, 73, 74) are set to conductive state and switches (52, 53, 71, 74) are set to none conductive state,
the circuit module will be seen externally as shown in FIG. 5A as a serial connection of the energy cells (91, 92, 93) with a none inverted polarity if switches (51, 54, 71, 74) are set to conductive state and switches (52, 53, 72, 73) are set to none conductive state,
the circuit module will be seen externally as shown in FIG. 5A as a serial connection of the energy cells (91, 92, 93) with an inverted polarity if switches (51, 52, 71, 74) are set to conductive state and switches (53, 54, 72, 73) are set to none conductive state.

FIG. 1A, 2A, 3A, 4A present principle circuit diagrams of a circuitry module according to one embodiment of the invention.

FIG. 1B, 2B, 3B, 4B present examples of circuit diagrams of a circuitry module according to one embodiment of the invention.

FIG. 5A presents a Module symbol for an Energy Module indicating a plurality of energy cells.

FIG. 5C presents an example of a three individual clusters of Energy Modules connected in parallel and in series.

FIG. 5D presents an example of three individual cluster of Energy Modules connected in series.

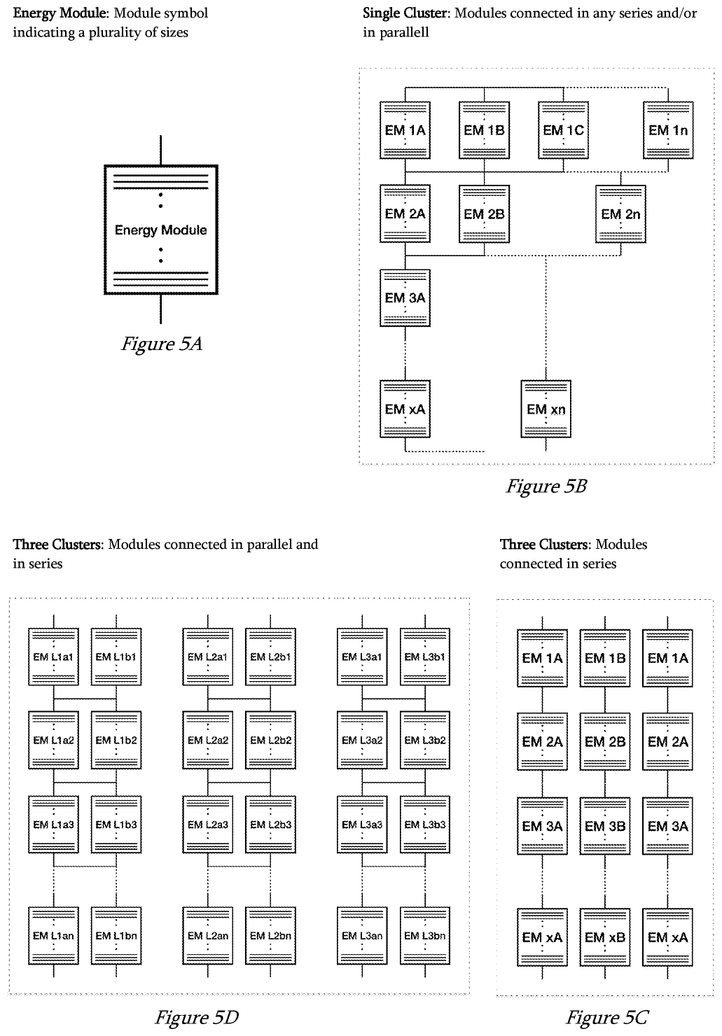

FIG. 6A is a cascaded circuitry similarity and assembled under the same principles as a circuit module claim 1, a structure of modules in a superstructure where each energy cell in the first level is replaced individually by at module in a plurality chain of modules, and for the subsequent plural levels of a superstructures where each energy cell equivalent module are replaced by a lower level module topology.

FIG. 6B is an example of a circuit diagram for FIG. 6A.

1. A circuit module for controlling a plurality of A circuit module for controlling a plurality of energy cell units,
the circuit module having two terminals for external connection connected to the switching assembly, the circuit module including a set of two terminals for each energy cell where the second terminal of the first cell is connected to the first terminal of the second cell, and where the second terminal of the second cell is connected to the first terminal of the third cell, for the connection to form a permanently connected serial chain of energy cells containing 3 or more energy cells,
the first terminal from the first (1) and every odd energy cell (1, 3, 5, 7 . . . ) following in the serial chain and the second terminal of the last cell in a chain with an even energy cell count (4, 6, 8, 10 . . . ) connected to a switching assembly,
the second terminal from the first (1) and of every odd energy cell (1, 3, 5, 7 . . . ) following in the serial chain connected to a switching assembly,
wherein the switching assemblies are operatively configured to selectively connect or disconnect each one of the energy cell units, each switching assembly including one or more switching devices, each switching device operable in a conductive state and a non-conductive state,
wherein the switching assemblies are operatively configured to selectively allow operating in a plurality of states,
a first state wherein the two terminals with a selectively arrangement of none conductive switches forms circuit module is an open circuit,
a second state wherein the two terminals of the circuit module is a short circuit, and wherein all energy cell units are selectively disconnected having the adjacent switches in a nonconductive state, having the short circuit path selectively arranged through a redundant network with more than one possible route of conductive switches and where alternative short connection routes are none are a overlapping use of conductive switches for all alternatives,
a third state wherein the two terminals of the module is a short circuit, wherein all energy cell units are disconnected having the switches selectively arranged in a way where a multiple of redundant switches are set to conductive state simultaneously resulting in a reduced switching equivalent active resistance,
a plurality of states depending on the length of the serial chain of energy cells wherein the two terminals of the module is selectively connected to one or an odd count of energy cells in which any single energy cell alone or with an odd count of selective number of successive energy cells in the serial chain in the module circuitry, each state including a charging cycle and a discharging cycle of the energy cell units connected in series.

2. A circuit module according to claim 1, where selective assembly of switches effectively will switch the polarity on the circuit module terminals.

3. A circuit module according to claim 1, where a switch device can be any type of electronic switch: BJT, MOSFET, IGBT, Thyristor, relay, and electromechanical switch.

4. A circuit module according to claim 1, where the circuit module is arranged for using PWM (pulse with modulation) by selectively alternating one or more switches at high speed together with filtration to generate higher voltage precision.

5. A circuit module according to claim 1, as standalone or a plurality of clusters used as motor controller, charger, inverter, transformer or other energy conversion devices.

6. An energy module comprising a circuit module according to claim 1, and the serial chain of energy cells.

7. An energy module according to claim 6, where an energy cell is a battery cell, capacitor, super-cap, or any other device that can store energy.

8. An energy cluster, comprising a plurality of energy modules according to claim 6, for energy input and output as charge and discharge and possibly both at the same time.

9. An energy cluster according to claim 8, comprising a plurality of energy modules connected in in serial, in parallel or in a plurality of combinations of parallel and serial combined.

10. An energy cluster according to claim 8, where the plurality of modules is arranged to modulate voltage and current to be DC, AC or other voltage and current with unspecified frequency spectrum.

11. An energy cluster according to claim 8, comprising a plurality of clusters configured to work together as 3-phase, 4-phases, 5 or more phases.

12. A cascaded circuitry arranged according to the circuit module according to claim 1, comprising a structure of modules in a superstructure where each energy cell in a first level is replaced individually by at module in a plurality chain of modules, and for the subsequent plural levels of a superstructures where each energy cell equivalents are replaced by a lower level module topology as in circuit module of claim 1.
